(19) United States
(12) Patent Application Publication
(10) Pub. No.: US 2018/0043568 A1
(43) Pub. Date: Feb. 15, 2018

(54) TOOL HANDLE PUSH STICK

(71) Applicant: Benjamin Alexander Morrison, Victoria (CA)

(72) Inventor: Benjamin Alexander Morrison, Victoria (CA)

(21) Appl. No.: 15/237,080

(22) Filed: Aug. 15, 2016

(51) Int. Cl. B27B 25/10; B25D 1/00; B25G 1/10

(52) U.S. Cl. CPC B27B 25/10; B25G 1/102; B25D 1/00

(57) ABSTRACT

According to a first embodiment of the present invention there is disclosed a tool handle comprising an elongate handle sized to be grasped by a user extending between its first and second ends along an axis, where the first end may be adapted to be engaged with and retain a tool therein, and the second end includes a notch in an end surface thereof adapted to engage upon a corner of a board. The handle may include an insert secured to a handle base having the second end thereon.

### BACKGROUND OF THE INVENTION

### 1. Field of Invention

The present invention relates generally to a safety device for use with power tools, and specifically to a tool handle which can be utilized as a push stick to engage and advance materials through a woodworking table saw.

### 2. Description of Related Art

When operating woodworking equipment, such as circular table saws, band saws, routers, jointers and similar stationary power tools, users must exercise caution so that they do not cause injury to any part of their body. A variety of safety devices may be employed for such purpose, including safety glasses, face shields, hearing protection and gloves. In particular, they must be careful not to injure their fingers or hands while advancing woodworking materials through the equipment.

Typically, a push stick is used to advance woodworking equipment through stationary power tools, such as a table saw. A push stick includes a handle that allows the user to guide the material past the saw blade while providing adequate distance between the cutting element and the user's hand, so as to prevent injury. Disadvantageously, push sticks are small and may be easily misplaced, and thus may not always be readily available when a user needs one.

There are several push stick designs available, however such devices may also be prone to being misplaced. Examples of single use push stick designs are U.S. Pat. No. Des. 278,022 (Ash), U.S. Pat. No. 6,135,521 (Wirth et al.), U.S. Pat. No. 6,044,740 (Werkheiser) and Des. 337,707 (McCord).

### SUMMARY OF THE INVENTION

According to a first embodiment of the present invention there is disclosed a tool handle comprising an elongate handle sized to be grasped by a user extending between its first and second ends along an axis, where the first end may be adapted to be engaged with and retain a tool therein, and the second end includes a notch in an end surface thereof adapted to engage upon a corner of a board.

The tool handle may include an insert secured to a handle base having the second end therein. The insert may be formed of wood. The handle may be formed of wood.

The notch may be formed of first and second notch surfaces, and the first and second notch surfaces form a notch angle therebetween. The notch angle may be 90 degrees. The first surface of the notch may be angled relative to the axis by an angle greater than the second surface of the notch.

According to a further embodiment of the present invention there is disclosed a hand tool comprising an elongate handle sized to be grasped by a user extending between first and second ends, a tool head secured to the first end, wherein the second end includes a notch in an end surface thereof adapted to engage upon a corner of a board.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a side view of a tool with a push stick end engaged with a workpiece.

FIG. 2 is a side view of the tool of FIG. 1.

FIG. 3 is a front view of the tool of FIG. 1.

FIG. 4 is an enlarged view of the notch of FIG. 2.

FIG. 5 is a side exploded view of the tool of FIG. 1 with a replaceable notch end according to a further embodiment of the present invention.

### DETAILED DESCRIPTION

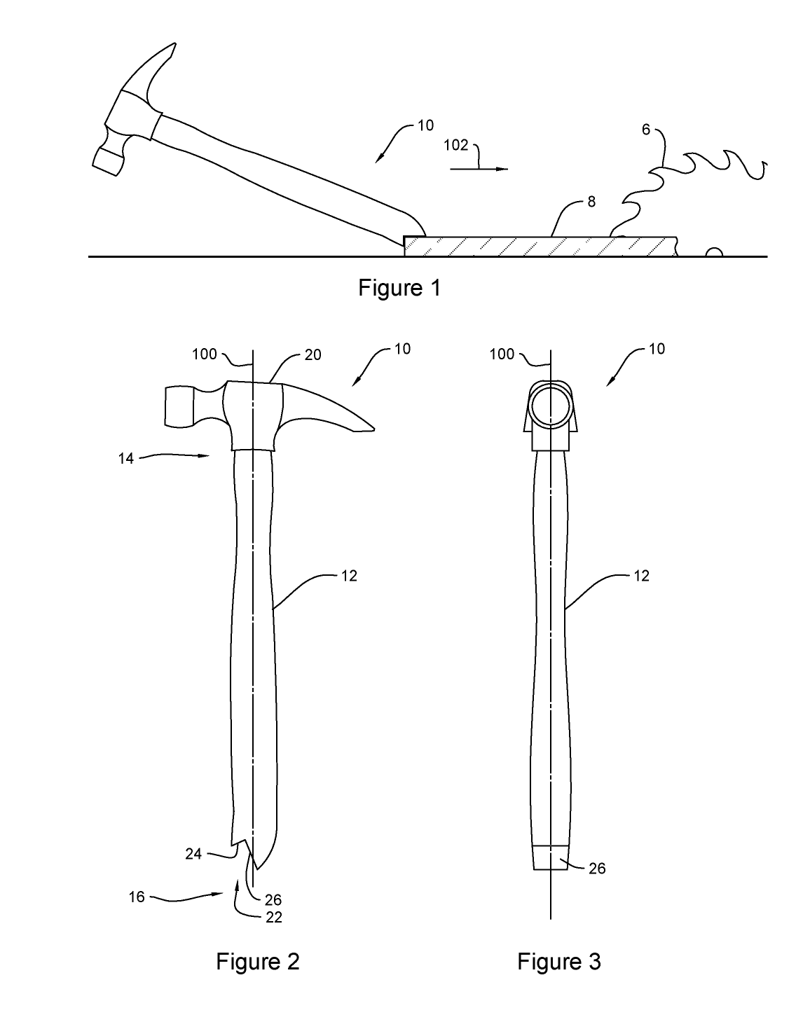

Referring to FIGS. 1 and 2, a tool for securely engaging and advancing a workpiece 8 through a cutting tool such as, by way of non-limiting example a table saw, according to a first embodiment of the invention is shown generally at 10. The tool 10 has an elongated handle 12 extending from a first end 14 to a second end 16 along a longitudinal axis 100 extending the length of the handle 12. The handle is sized and shaped to be grasped by a user, as is commonly known. A hammer head 20 may be attached to the first end 14 of the handle 12 by any known means in the art. Although a traditional curved claw hammer head is illustrated, it may be appreciated that other forms of hammer heads or other tool types may be useful, as well. The handle 12 may be made of any suitable material as are commonly known, such as, by way of non-limiting example, wood, plastic or composite materials, as is common in the art.

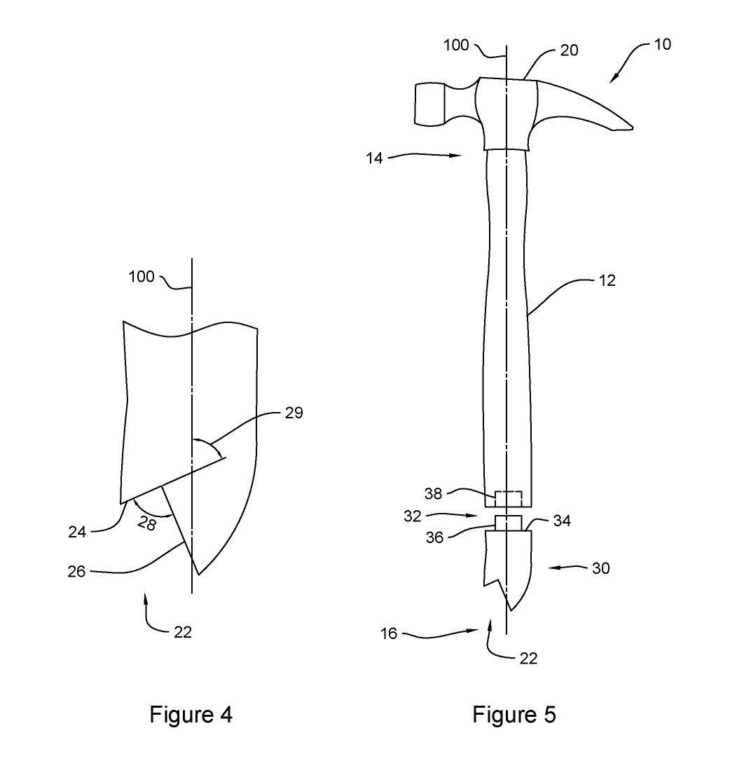

As best seen in FIG. 4, a notch 22 is formed into the second end 16 of the handle 12. The notch has first and second surfaces 24 and 26, respectively. The notch surfaces 24 and 26 form a notch angle 28 therebetween. The notch angle 28 is selected to be useful in engagement upon a workpiece such as, by way of non-limiting example, 90 degrees such that the notch 22 may engage with the end of a workpiece 8 as shown in FIG. 1, although it will be appreciated that other angles may be useful as well. The first notch surface 24 is formed at an angle 29 from the tool axis 100, and may be optionally less than 45 degrees such that when engaged with a workpiece 8 the first end 14 of the tool 10 will be at a greater elevation than the second end 16, as illustrated in FIG. 1.

In operation, a user may position the notch 22 around the edge of a workpiece 8 for advancing such workpiece past a table saw 6. Thereafter, continued movement in a direction generally indicated at 102 will complete the path of the workpiece past the table saw while keeping the user's hands and fingers at a safe distance. It will be appreciated that as the tool 10 is also useful as a hammer, a user will most commonly have such tool with them thereby reducing the risk of loss of the tool.

Turning now to FIG. 5, an alternate embodiment of the invention, with a detachable insert 30 is illustrated. The insert 30 extends from an insert connection 32 to the second end 16, as previously defined. The insert 30 has a top surface 34 at the insert connection with a protruding tenon 36 extending therefrom, formed in a size and shape as is commonly known. A cavity mortise 38 is formed in the handle 12 and is sized and shaped to receive the tenon 36. The tenon 36 and mortise 38 may be temporarily secured together by any known means, such as, by way of non-limiting example, screws through the handle 12 and the tenon 36. By utilizing a detachable insert 30, the insert 30 may be replaced when damaged, rather than replacing the entire tool. The insert 30 may be made of wood, while the handle 12 may be made of another suitable material such as, by way of non-limiting example, fibreglass or the like.

While specific embodiments of the invention have been described and illustrated, such embodiments should be considered illustrative of the invention only and not as limiting the invention as construed in accordance with the accompanying claims.

What is claimed is:

1. A tool handle comprising an elongate handle sized to be grasped by a user extending between first and second ends along an axis, wherein said first end is adapted to be engaged with and retain a tool therein, wherein said second end includes a notch in an end surface thereof adapted to engage upon a corner of a board.

2. The tool handle of claim 1 wherein said handle includes an insert secured to a handle base having said second end thereon.

3. The tool handle of claim 2 wherein said insert is threadably secured to said handle base.

4. The tool handle of claim 2 wherein said insert is formed of wood.

5. The tool handle of claim 1 wherein said handle is formed of wood.

6. The tool handle of claim 1 wherein said notch is formed of first and second notch surfaces.

7. The tool handle of claim 6 wherein said first and second notch surfaces form a notch angle therebetween.

8. The tool handle of claim 7 wherein said notch angle is 90 degrees.

9. The tool handle of claim 8 wherein said first surface of said notch is angled relative to said axis by an angle greater than said second surface of said notch.

10. A hand tool comprising an elongate handle sized to be grasped by a user extending between first and second ends, a tool head secured to said first end, wherein said second end includes a notch in an end surface thereof adapted to engage upon a corner of a board.
